(19) United States
(12) Patent Application Publication
(10) Pub. No.: US 2026/0096712 A1
(43) Pub. Date: Apr. 9, 2026

(54) Rotatable Squeegee With Adjustable Blade Angle

(71) Applicant: Jeff Chen, Houston, TX (US)

(72) Inventor: Jeff Chen, Houston, TX (US)

(21) Appl. No.: 18/907,592

(22) Filed: Oct. 7, 2024

(51) Int. Cl. A47L 13/11; B25G 1/04; B25G 3/38

(52) U.S. Cl. CPC A47L 13/11; B25G 1/04; B25G 3/38

(57) ABSTRACT

An innovative rotatable squeegee is disclosed configured to enhance cleaning efficiency and versatility. The squeegee comprises a blade having a slanted front portion and a rear portion having an elongated member. The elongated member includes a pair of well members attached to an eye end. The eye end has a hollow interior and an exterior configured with multiple teeth. The handle comprises a proximal end with at least one extension pole and a distal end that incorporates a fork end and an annular cup. The fork end contains a clamping bore while the annular cup is fitted with extended teeth that interlock with the teeth of the eye end to facilitate smooth rotational movement between the handle and the blade. The innovative blade design allows users to access hard-to-reach areas, reducing physical strain by eliminating the need to bend or squat during use.

### TECHNICAL FIELD

The present invention generally relates to cleaning tools. More specifically, the invention is a rotatable squeegee with an adjustable blade angle. The innovative design allows for enhanced flexibility and efficiency in window or glass cleaning, enabling users to easily adapt to various surface angles and shapes while minimizing physical strain and improving overall cleaning effectiveness.

### BACKGROUND

The background description includes information that may be useful in understanding the present invention. It is not an admission that any of the information provided herein is prior art or relevant to the presently claimed invention, or that any publication specifically or implicitly referenced is prior art.

Traditionally, window cleaning has long relied on the use of a standard squeegee that is a simple, yet effective tool designed with a rubber blade attached to a handle. The approach has been widely adopted in both residential and commercial areas where clean windows enhance visibility and the aesthetic appeal of buildings. The squeegee's ability to glide smoothly across glass surfaces allows users to effectively remove water, dirt, and grime thereby achieving a flawless finish. However, while the simplicity and efficiency of the squeegee made it a go-to solution for many years, it also presents several inherent limitations that can hinder optimal performance, particularly in modern cleaning scenarios.

One of the main challenges associated with traditional squeegees is their fixed blade angle. The rigidity makes it difficult to clean windows at awkward angles or in hard-to-reach areas often forcing users to bend their bodies, lean over ledges or use ladders. In particular, when a user wipes a vertical surface, the user needs to bend his body to wipe lower portion of the vertical surface to effectively clean the vertical surface. Such practices can pose significant safety risks and lead to physical strain or fatigue particularly for professional cleaners who manage multiple properties throughout the day. The physical exertion required not only detracts from efficiency but also raises concerns about the long-term well-being of users.

Moreover, traditional squeegees are less effective on windows with intricate designs or architectural features such as divided panes or decorative frames. The inflexible construction of the blade may not conform adequately to these variations, resulting in missed spots and unsightly streaks. This is especially problematic in high-end residential properties or commercial buildings where aesthetic standards are paramount. The inability to achieve a thorough clean can necessitate additional cleaning efforts, ultimately impacting the quality of work.

The window cleaning process typically involves multiple steps that include applying cleaning solutions, scrubbing surfaces, and then using the squeegee to remove excess water. The extended procedure can be time-consuming particularly in large spaces, where maintaining cleanliness is essential for safety and visual appeal. For professional cleaners, the inefficiencies inherent in the method can translate to fewer jobs completed in a day, affecting overall productivity and profitability.

In addition to window cleaning, squeegees find applications in bathrooms where these help to prevent soap scum and mildew build ups by swiftly removing water from shower doors and tiles. These are also utilized for floor care in commercial settings where user push water and cleaning solutions across hard surfaces. During car washes, squeegees are employed to remove excess water from vehicles, ensuring a clean finish. Beyond cleaning tasks, squeegees are essential in screen printing, spreading ink evenly across screens for design transfers, and are used by artists to apply and blend paints.

Despite their versatility and effectiveness, the limitations of traditional squeegees highlight a pressing need for innovative solutions that enhance both efficiency and ergonomics. There is a need for an invention that has a rotatable squeegee to address the challenges by incorporating a pivoting mechanism that allows the handle to change position of push while blade remain in contact to the vertical surface. The design provides greater flexibility, enabling users to conform the blade to various surfaces and reach awkward angles without excessive movement or repositioning. By minimizing physical strain and improving manoeuvrability, such innovations can make window cleaning safer and more efficient, ultimately meeting the demands of modern users.

### SUMMARY

The present invention relates to a rotatable squeegee with an adjustable blade angle, designed to enhance the efficiency and comfort of cleaning various surfaces, such as windows and tiles. In particular, the objective of the present invention is to provide a rotatable squeegee which while in use, the user may manoeuvre or reposition the handle in order to apply push force on the blade without removing the surface contact of the blade so that user don't need to bend his body to clean lower part of a vertical surface. In an embodiment, the innovative squeegee includes a blade that can rotate to maintain an angle from top to bottom when placed against a surface. By incorporating a pivot mechanism, the blade rotates at varying angle. The squeegee enables users to effectively clean away water stains, dust, or marks without the need for bending or leaning. The design significantly reduces physical strain on the user, promoting a more ergonomic cleaning experience. By addressing the limitations of traditional squeegees, the invention enhances overall convenience and satisfaction for users, making it a valuable advancement in cleaning tools. The solution ensures that users can achieve optimal cleaning results without discomfort, thereby optimizing the cleaning process.

In an embodiment of the present invention, a rotatable squeegee comprises a blade and a handle. The handle is configured to rotate between at least two positions by a user. In the first position, a downward pull stroke is applied to the blade positioning the blade at a higher position than the handle to wipe an upper portion of a vertical surface. In the second position, a downward push stroke is applied to the blade which is situated lower than the handle for cleaning a lower portion of the vertical surface. In addition, the handle is configured to rotate anticlockwise at the second position from the first position to apply the downward push stroke on the blade and wipe lower portion of the vertical surface. The rotation is through a hinge joint connection between the handle and blade.

In an embodiment of the present invention, the invention discloses a rotatable squeegee configured to enhance the efficiency and comfort of cleaning various surfaces. The rotatable squeegee comprises a blade and a handle. The blade of the squeegee includes a slanted front portion and a rear portion having an elongated member. The elongated member comprises a pair of well member positioned on either side of an eye end having an interior portion and an exterior portion. The interior portion of the eye end is configured to a hollow opening. The exterior portion of the eye end is configured to have a plurality of teeth. Further, the handle of the squeegee includes a proximal end having at least one extension pole and a distal end having a fork end and an annular cup. Moreover, the fork end comprises a clamping bore. The annular cup comprises a plurality of extended teeth. Furthermore, the annular cup is configured to receive the eye end of the elongated member. Additionally, the plurality of teeth of the eye end and the teeth of the annular cup facilitate interlocking rotation between the handle and the blade to allow controlled rotation. The fork end and the eye end are coupled together by a hinge joint.

In one of the embodiments of the present invention, the grip portion is formed of a non-slip material for improved handling.

In one of the exemplary embodiments of the present invention, the blade is configured to wipe a vertical surface; the vertical surface is divided into an upper vertical surface and a lower vertical surface. In the embodiments of the present invention, the upper vertical surface is wiped by a downward pull force and the vertical lower surface is wiped by a downward push stroke by shifting the handle position in an anticlockwise direction.

In the embodiment of the present invention, the hinge joint comprises a clamping bolt and nut assembly to couple the fork end and the eye end.

In one of the embodiments of the present invention, the extension poles are configured with at least a stopper to adjust the handle length.

In one of the embodiments of the present invention, the circular shaped eye end is connected with each of the well member on either side.

In one of the embodiments of the present invention, the diameter of the hollow opening of the eye end is similar to the diameter of the clamping bore of the fork end.

In one of the embodiments of the present invention, the removable blade is made of a durable, non-corrosive material selected from the group consisting of rubber, silicone, polyurethane etc.

In one of the embodiments of the present invention, the handle is composed of a lightweight, high-strength polymer material that provides durability while ensuring ease of handling and user comfort.

In one of the embodiments of the present invention, the hinge joint is made from stainless steel to ensure corrosion resistance and maintain integrity under various environmental conditions.

In an embodiment, a method of cleaning a vertical surface by a dual use of a handle of a rotatable squeegee is disclosed. The method comprising steps of positioning the handle at a tilted angle to facilitate cleaning of an upper vertical surface. Providing a downward pull stroke on the handle to engage a blade with the upper vertical surface while maintaining the handle in the tilted position. Rotating the handle anticlockwise by means of a hinge joint to a predetermined position and applying a downward push stroke with the handle from the predetermined position to clean a lower vertical surface.

For further clarification of the features and other embodiments of the invention, a more particular description is provided that will further explain the features and advantage of the invention with the illustration or the drawings. As will be appreciated, other embodiments of the present invention are possible utilizing, alone or in combination, one or more of the features set forth above or described in detail below.

### BRIEF DESCRIPTION OF THE DRAWINGS

A full understanding of the invention can be gained from the following description of the preferred embodiments when read in conjunction with the accompanying drawings in which:

FIG. 1A illustrates a perspective view of a squeegee, in according to embodiments of the present invention disclosed herein;

FIG. 1B illustrates a perspective view of a squeegee with extendable handle, in according to embodiments of the present invention disclosed herein;

FIG. 2A illustrates a perspective view of a rear portion of the blade having an elongated member with an eye end, in according to embodiments of the present invention disclosed herein;

FIG. 2B illustrates a perspective view of a distal end of the handle including a fork end, in according to embodiments of the present invention disclosed herein;

FIG. 2C illustrates a cross-sectional view of the distal end of the handle including a fork end, in according to embodiments of the present invention disclosed herein;

FIG. 3A illustrates a perspective view of a squeegee allowing a pull stroke on an upper portion of a vertical surface, in according to embodiments of the present invention disclosed herein;

FIG. 3B illustrates method of using the squeegee, the handle of which is manoeuvred upside to apply push stroke on a lower portion of the vertical surface, in according to embodiments of the present invention disclosed herein;

FIG. 3C illustrates a flow diagram of method of cleaning a vertical surface using the squeegee, in according to embodiments of the present invention disclosed herein;

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

References will now be made in detail to the presently preferred embodiments of the invention, examples of which are illustrated in the accompanying drawings. Throughout the following detailed description, the same reference numerals refer to the same elements in all figures.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and it is not intended to be limiting the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the following description, reference will be made to the accompanying drawing, in which comparable functional elements are designated with like numerals. The aforementioned accompanying drawings show by way of illustration and not by the way of limitation, specific aspects and implementations consistent with principles of this disclosure. These implementations are described in sufficient detail to enable those skilled in the art to practice the disclosure and it is to be understood that other implementations may be utilized, and that structural changes and/or substitutions of various elements may be made without departing from the scope and spirit of this disclosure. The following detailed description is, therefore, not to be construed in limited sense. It is noted that description herein is not intended as an extensive overview, and as such, concepts may be simplified in the interests of clarity and brevity. All documents mentioned in this application are hereby incorporated by reference in their entirety.

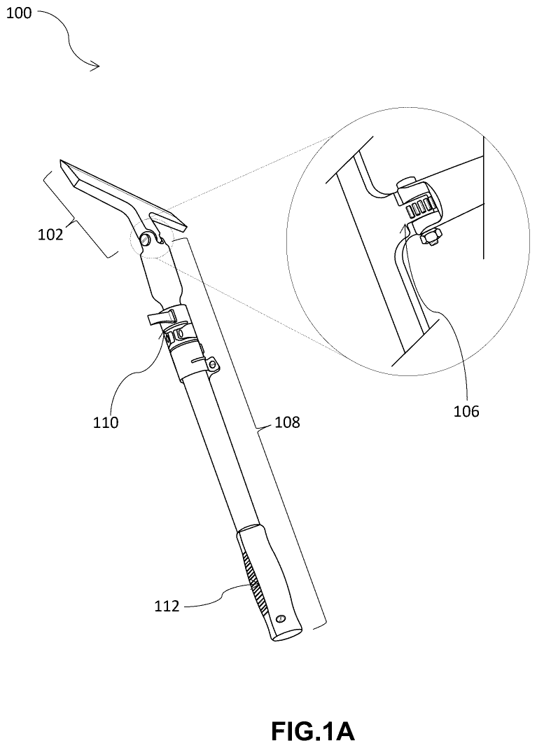

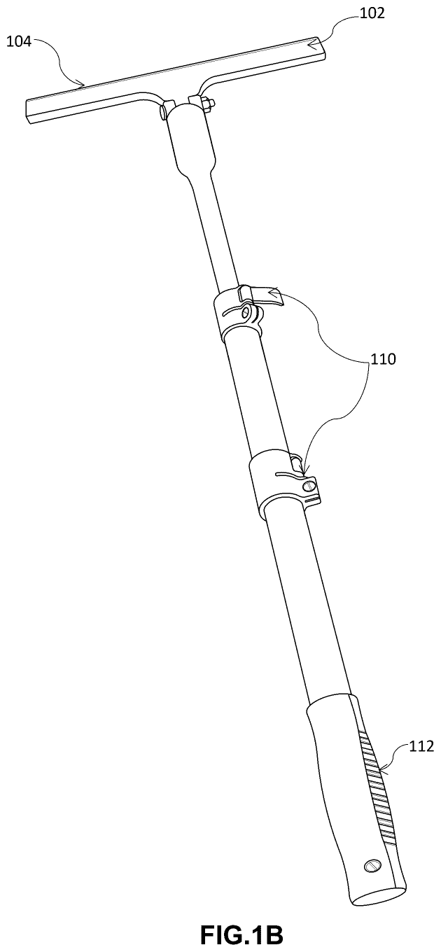

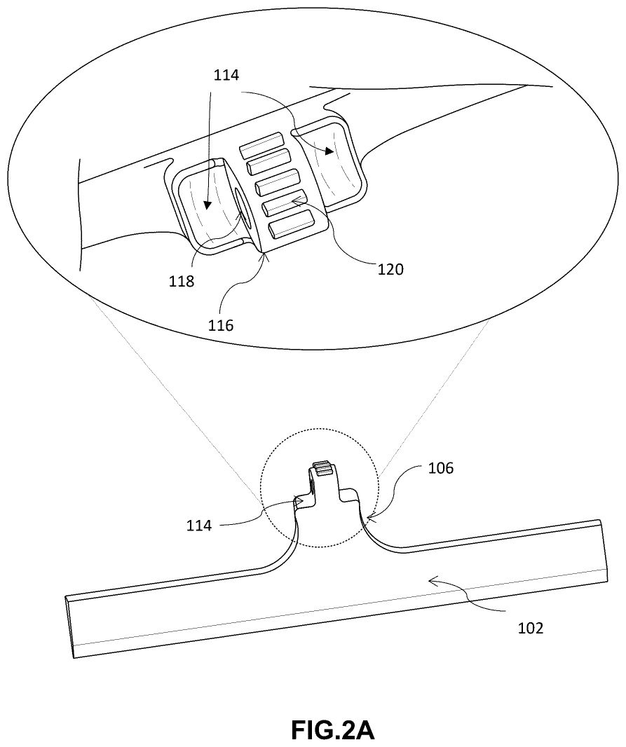

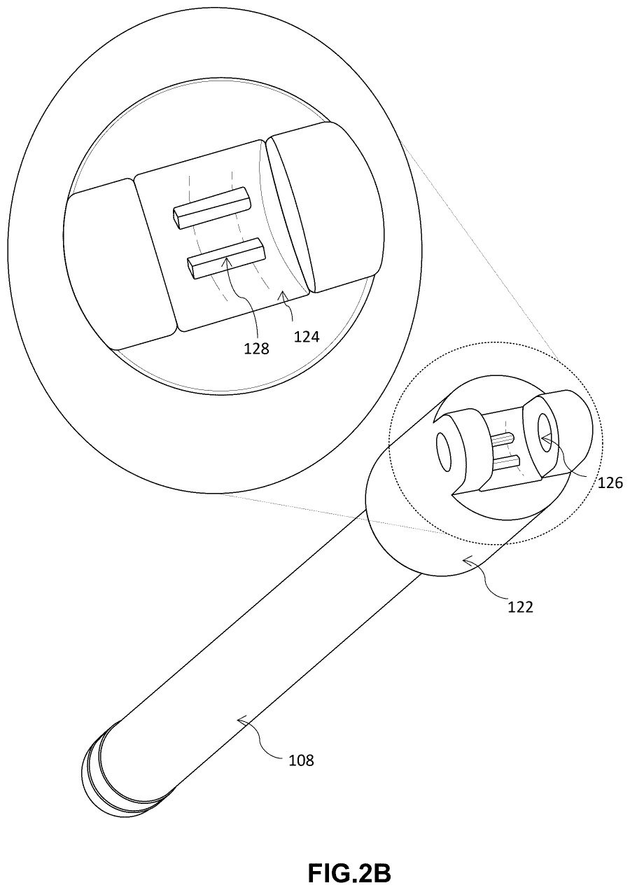

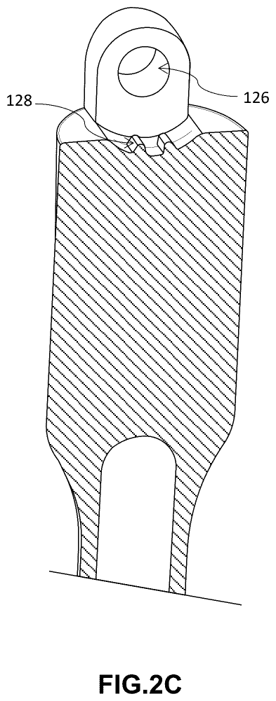

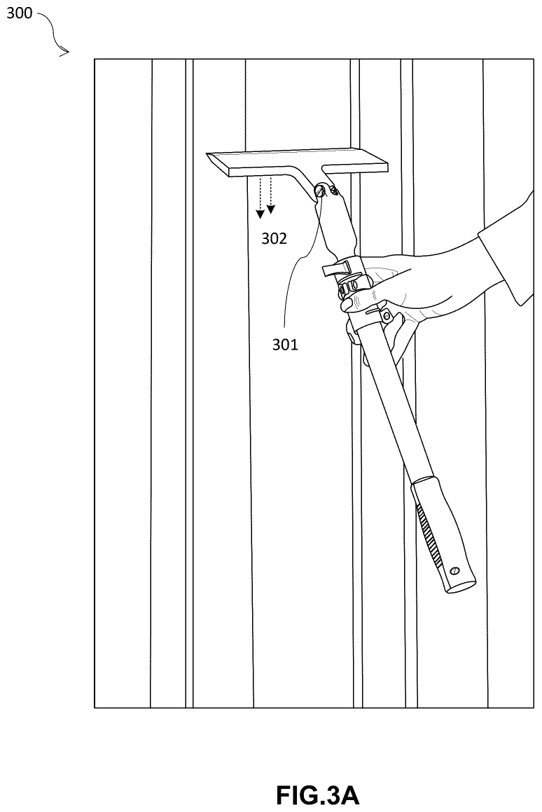

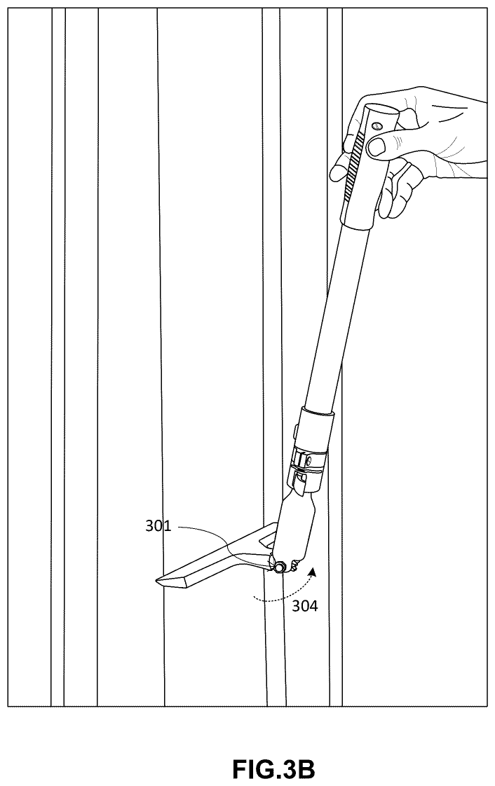

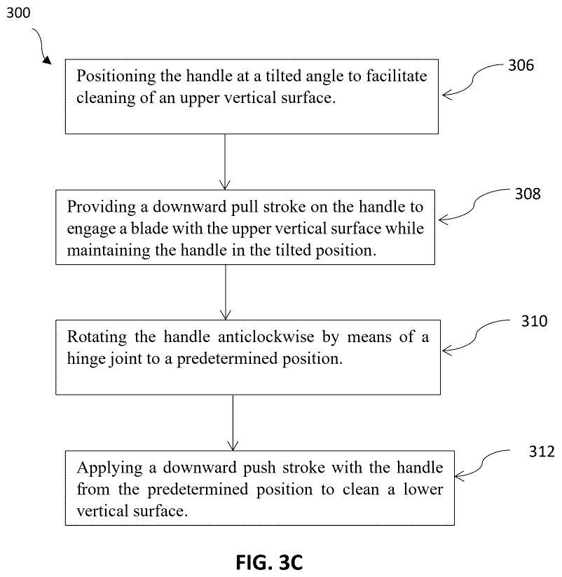

According to the embodiment of the present invention, a squeegee 100 is shown in FIG. 1A-FIG. 1B. The squeegee 100 is designed to enhance efficiency and user experience in cleaning tasks. The squeegee 100 according to the present disclosure includes a blade 102 that includes a slanted front portion 104 that facilitates the effective removal of liquids and debris from various surfaces such as windows, tiles, walls etc. The blade 102 includes a rear portion having an elongated member 106. In addition, the handle 108 complements the blade 102 which comprises a proximal end and a distal end. The proximal end of the handle 108 incorporates at least one extension pole 110 with a stopper allowing users to adjust the handle length based on their height or the specific cleaning task at hand. In the embodiment, there may be more than one stoppers in the handle 108. The topper is configured to have lockable and unlockable feature to adjust the length of the extension poles 110. The lockable specific locking feature ensures the handle 108 easily reverted back to a compact size when not in use, enhancing compactness and storage convenience. In the embodiment, the handle may include a grip portion 112 which is formed of an anti-slip material for improved handling even in wet conditions. The grip allows the user to maintain a secure hold, minimizing the risk of slippage during operation. In reference to FIG. 2A, the elongated member 106 of the blade 102 includes a pair of well members 114 positioned on either side of an eye end 116. The eye end 116 comprises an interior portion configured to a hollow opening 118 and an exterior portion configured to a plurality of teeth 120 inclined at varying angles. Further, in reference to the FIG. 2B-FIG 2C, the distal end of the handle 108 comprises a fork end 122 and an annular cup 124. In the embodiment, the fork end 122 includes a pair of clamping bores 126 that securely holds the eye end of the elongated member of the blade by clamping bolt and nut in a hinge joint. The annular cup 124 includes a plurality of extended teeth 128 at its interior surface. Further, when the user apply pressure and move the squeegee 100, the angled teeth 120 of the eye end 116 slides into the corresponding gaps in between the extended teeth 128 of the fork end 122. The connection is not merely a straightforward insertion, rather than teeth 120 of eye end 116 are placed at varying angles to create a locking effect as they engage. The inclined nature of the teeth allows them to interlock securely, preventing any lateral movement while still allowing for smooth rotational motion. In reference to FIG. 3A to FIG. 3C, a hinge joint 301 of the squeegee 300 is configured to connect the fork end and the eye end. The hinge joint comprises a clamping bolt and nut assembly. The hinge joint 301 is designed to allow for quick adjustments thus enabling users to modify the blade's angle with ease. Such flexibility is essential as it permits the squeegee to operate in two distinct modes. In the embodiment, when the user applies downward pull stroke 302, the squeegee maintains a consistent angle with the surface, maximizing pressure distribution for efficient cleaning. Similarly, in rotated mode 304, the user applies downward push stroke by altering the blade's angle via the hinge joint 301 thus allowing for effective cleaning of hard-to-reach areas without requiring excessive bending, leaning, or squatting of the user body towards the surface. Furthermore, in particular FIG. 3C, discloses method 300 of cleaning a vertical surface using the squeegee using rotatable handle. The method includes various steps including step 306 which discloses positioning the handle at a tilted angle to facilitate cleaning of an upper vertical surface. The handle may be rotated between at least two distinct positions thereby, allowing for versatile use on vertical surfaces such as windows and walls. In the embodiment, the step 308 discloses providing a downward pull stroke on the handle to engage a blade with the upper vertical surface while maintaining the handle in the tilted position. The positioning of the handle at a tilted angle along the vertical surface allows user to wipe away dirt, moisture, or grime effectively and comfortably. Additionally, the step 310 discloses the user cleaning the lower portion of a vertical surface by simply rotating the handle to its second position or a predetermined position, where the handle positions above the blade. In step 312, the method provides a downward push stroke which is ideal for reaching lower areas such as the base of walls or the lower panes of windows. The seamless transition between positions not only maximizes the squeegee's cleaning capability but also prevents users from facing any physical strain or pain by preventing excessive bending or leaning along the surface. The hinge joint connection between the handle and the blade is crucial for the squeegee's functionality. The hinge joint enables smooth and secure rotation ensuring that the handle can pivot easily between the two positions. The mechanism is designed for durability, capable of withstanding regular use while providing reliable performance. Further, the anticlockwise rotation of the handle ensures that the blade remains optimally positioned for each stroke, minimizing the chances of missing spots and ensuring thorough cleaning results.

In an embodiment, a rotatable squeegee comprising a blade and a handle, the handle is configured to rotate between at least two positions by a user. A downward pull stroke is applied to the blade at a first position of the handle to wipe an upper portion of a vertical surface, wherein the blade is at a higher position than the handle. a downward push stroke is applied to the blade at a second position of the handle for cleaning a lower portion of the vertical surface, wherein the blade is at lower position than the handle. The handle is configured to rotate anticlockwise at the second position from the first position to apply the downward push stroke on the blade and wipe lower portion of the vertical surface, wherein rotation is through a hinge joint connection between the handle and blade.

In one of the embodiments of the present invention, the blade of the squeegee is designed to wipe a vertical surface which is divided into an upper and lower surface. The upper surface is cleaned using a downward pull force while the lower surface is addressed with a downward push force by shifting the handle anticlockwise. The dual-action approach allows users to efficiently clean both sections without excessive strain, enhancing the overall effectiveness of the squeegee for various cleaning tasks.

In one of the embodiments of the present invention, the handle is composed of a lightweight, high-strength polymer material that provides durability while ensuring ease of handling and user comfort.

In one of the embodiments of the present invention, the hinge joint is made from stainless steel to ensure corrosion resistance.

In one of the embodiments of the present invention, the removable blade is made of a durable, non-corrosive material selected from the group consisting of rubber, silicone, polyurethane etc.

In one of the embodiments of the present invention, the diameter of the hollow opening of the eye end is similar to the diameter of the clamping bore of the fork end.

In one of the embodiments of the present invention, the circular shaped eye end is connected with each of the well member on either side.

It should be understood that the examples provided herein are intended only for purposes of illustration and any number of other implementations is also contemplated. Additionally, the referenced examples (including the described rules and/or other techniques) can be combined in any number of ways.

Although an overview of the inventive subject matter has been described with reference to specific example implementations, various modifications and changes can be made to those implementations without departing from the broader scopes of implementation of the present disclosure. Such implementation of the inventive subject matter can be referred to herein, individually or collectively, by the term “invention” merely for convenience without intending to voluntarily limit the scope of this application to any single disclosure or inventive concept if more than one is, in fact is disclosed.

The implementations illustrated herein are described in sufficient detail to enable those skilled in the art to practice the teachings disclosed. Other implementations can be used and derived therefrom, such that structural substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources or structures described herein as a single instance. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A rotatable squeegee comprising:
a blade; and
a handle, the handle is configured to rotate between at least two positions by a user;
wherein a downward pull stroke is applied to the blade at a first position of the handle to wipe an upper portion of a vertical surface, wherein the blade is at a higher position than the handle;
wherein a downward push stroke is applied to the blade at a second position of the handle for cleaning a lower portion of the vertical surface, wherein the blade is at lower position than the handle;
wherein the handle is configured to rotate anticlockwise at the second position from the first position to apply the downward push stroke on the blade and wipe lower portion of the vertical surface, wherein rotation is through a hinge joint connection between the handle and blade.

2. The rotatable squeegee as claim in claim 1, wherein the blade includes a slanted front portion and a rear portion having an elongated member, the elongated member comprises:
a pair of well member positioned on either side of an eye end, the eye end comprising an interior portion and an exterior portion;
wherein the interior portion of the eye end configured to a hollow opening and the exterior portion of eye end configured to a plurality of teeth;
the handle having a proximal end and a distal end, the proximal end comprises at least one extension pole,
wherein the distal end includes a fork end and an annular cup;
wherein the fork end comprising clamping bores and the annular cup having a plurality of extended teeth;
wherein the annular cup is configured to receive the eye end of the elongated member; and
wherein the plurality of teeth of the eye end, and the teeth of the annular cup facilitate the interlocking rotation between the handle and the blade, wherein the fork end and the eye end are coupled together by the hinge joint.

3. The rotatable squeegee as claimed in claim 1, wherein the hinge joint comprises a clamping bolt and nut assembly to couple the fork end and the eye end.

4. The rotatable squeegee as claimed in claim 1, wherein the extension poles are configured with at least a stopper to adjust the handle length.

5. The rotatable squeegee as claimed in claim 1, wherein the circular shaped eye end is connected with each of the well member on either side.

6. The rotatable squeegee as claimed in claim 1, wherein the diameter of the hollow opening of the eye end is similar to the diameter of the clamping bore of the fork end.

7. The rotatable squeegee as claimed in claim 1, wherein the removable blade is made of a durable, non-corrosive material selected from the group consisting of rubber, silicone, polyurethane etc.

8. A rotatable squeegee comprising:
a blade; and
a handle;
the blade includes a slanted front portion and a rear portion having an elongated member, the elongated member comprises:
a pair of well member positioned on either side of an eye end, the eye end comprising an interior portion and an exterior portion;
wherein the interior portion of the eye end configured to a hollow opening and the exterior portion of eye end configured to a plurality of teeth;
the handle having a proximal end and a distal end, the proximal end comprises at least one extension pole,
wherein the distal end includes a fork end and an annular cup;
wherein the fork end comprising clamping bores and the annular cup having a plurality of extended teeth;
wherein the annular cup is configured to receive the eye end of the elongated member; and
wherein the plurality of teeth of the eye end, and the teeth of the annular cup facilitate interlocking rotation between the handle and the blade, wherein the fork end and the eye end are coupled together by a hinge joint.

9. The rotatable squeegee as claimed in claim 8, wherein the handle comprises a grip portion formed of a non-slip material.

10. The rotatable squeegee as claimed in claim 8, wherein the blade is configured to wipe a vertical surface.

11. The rotatable squeegee as claimed in claim 8, wherein an upper vertical surface is wiped by a downward pull stroke and a lower vertical surface is wiped by a downward push stroke by shifting the handle position in an anticlockwise direction.

12. The rotatable squeegee as claimed in claim 8, wherein the hinge joint comprises a clamping bolt and nut assembly to couple the fork end and the eye end.

13. The rotatable squeegee as claimed in claim 8, wherein the extension poles are configured with at least a stopper to adjust the handle length.

14. The rotatable squeegee as claimed in claim 8, wherein the circular shaped eye end is connected with each of the well member on either side.

15. The rotatable squeegee as claimed in claim 8, wherein the diameter of the hollow opening of the eye end is similar to the diameter of the clamping bore of the fork end.

16. The rotatable squeegee as claimed in claim 8, wherein the removable blade is made of a durable, non-corrosive material selected from the group consisting of rubber, silicone, polyurethane etc.

17. The rotatable squeegee as claimed in claim 8, wherein the handle is constructed from a lightweight, high-strength polymer material.

18. The rotatable squeegee as claimed in claim 8, wherein the hinge joint is made from corrosion resistance stainless steel.

19. A method of cleaning a vertical surface by a dual use of a handle of a rotatable squeegee, the method comprising:
positioning the handle at a tilted angle to facilitate cleaning of an upper vertical surface;
providing a downward pull stroke on the handle to engage a blade with the upper vertical surface, maintaining the handle in the tilted position;
handle anticlockwise by means of a hinge joint to a predetermined position; and
applying a downward push stroke with the handle from the predetermined position to clean a lower vertical surface.

20. The method as claimed in claim 19, wherein the method comprising cleaning of the vertical surface without bending body of a user.
